(19) United States
(12) Patent Application Publication
(10) Pub. No.: US 2015/0154313 A1
(43) Pub. Date: Jun. 4, 2015

(54) A METHOD, DEVICE, BROWSER AND PROGRAM FOR ACCESSING WEB PAGE

(71) Applicants: Xiaobin Zong, Beijing (CN); Yuanzhen Ma, Beijing (CN); Weihua Tao, Beijing (CN)

(72) Inventors: Xiaobin Zong, Beijing (CN); Yuanzhen Ma, Beijing (CN); Weihua Tao, Beijing (CN)

(73) Assignee: BEIJING QIHOO TECHNOLOGY COMPANY LIMITED, Beijing (CN)

(21) Appl. No.: 14/345,648

(22) PCT Filed: Sep. 13, 2012
(86) PCT No.: PCT/CN2012/081345

§ 371 Date: Mar. 18, 2014

(30) Foreign Application Priority Data
Sep. 19, 2011 (CN) 201110278365.7

(51) Int. Cl. G06F 17/30

(52) U.S. Cl. CPC G06F 17/30902

(57) ABSTRACT

The present invention disclosed a method, a device and a browser for accessing to webpage to solve a problem of no cache at first access of the browser. The method comprises: creating an optimized cache area locally in advance, and preloading all webpage data required to be accessed in the optimized cache area; and when a webpage access request is initiated, querying whether the webpage data corresponding to the webpage access request is stored in the optimized cache area, if stored, reading the webpage data directly from the optimized cache area; if not stored, triggering a defaulted cache mechanism of a browser to query whether the webpage data is stored in a default cache area of the browser. The present invention may increase the access speed to webpage (especially having complex webpage script), and avoid the cache from being cleaned automatically by the browser.

### FIELD OF THE INVENTION

The present invention relates to a network technology, and in particular, to a method, a device, a browser and a program of accessing to webpage.

### BACKGROUND OF THE INVENTION

In the process of accessing to web pages, a browser may support webpage caching mechanism in order to improve the accessing speed. For example, the IE (Internet Explorer) browser owned by Windows system itself may adopt a method of cumulative acceleration to realize the webpage caching, that is, webpage contents (including images and Cookie files, etc.) that a user has ever accessed to are stored in the user's computer, and with the increment in the amount of the user accessing to web pages, the cache is cumulated. When the same webpage is accessed next time, the browser may search the cache directory first. If the contents that have been accessed are stored in the cache directory, there is no need for the browser to download the contents from network, but directly read the contents from the local cache, thereby increasing the speed of accessing to the website.

Meanwhile, the size and the number of the cache are limited, thus the browser itself has a set of cache cleaning mechanism. Once the space in the cache area occupied by files or the number of files exceeds a certain amount, the cache cleaning mechanism of the browser may be triggered. For example, the IE browser may evaluate a weight value for each cache file, and then clean the last 10% of the cache files. Algorithms of the weight are different from each other for various IE versions.

To sum up, the webpage caching mechanism generally adopted by the browser provides an increase in the speed of accessing to web pages in a certain extent. However, it also has the following defects:

1) A defect of no cache at first access of the browser;
At present, most of the browsers adopt the method of cumulative acceleration to realize webpage caching. Since the cache files of web pages may be obtained only after the first access, the contents of the first access must be downloaded from a server. Thereby, it is hard to increase the access speed at first access.
2) A defect of the cache being cleaned by the browser or other cleaning software regularly.

Each browser itself has a set of cache cleaning mechanism. Once the cache files are oversized, the cache files to be cleaned can only be decided according to the cleaning mechanism of the browser. However the cleaning mechanism is unable to identify which cache file is critical or important, and the website is also unable to control not to clean its cache pages. Therefore, some important files may be cleaned, which results to a problem of slowness of loading.

### SUMMARY OF THE INVENTION

Taking above problems into consideration, the present invention provides a method for accessing to webpage and a corresponding device thereof and a browser and a program for accessing to webpage, so as to overcome or at least solve partially or relieve the above problems.

According to an aspect of the present invention, a method for accessing to webpage is provided, which comprises: creating an optimized cache area locally in advance, and preloading all webpage data required to be accessed in the optimized cache area; and

when a webpage access request is initiated, querying whether the webpage data corresponding to the webpage access request is stored in the optimized cache area, if stored, reading the webpage data directly from the optimized cache area; if not stored, triggering a defaulted cache mechanism of a browser to query whether the webpage data is stored in a default cache area of the browser.

According to another aspect of the present invention, a device for accessing to webpage is provided, which comprises:

an optimized cache area creating module, adapted to create an optimized cache area locally in advance;
a preloading module, adapted to preload all webpage data required to be accessed in the optimized cache area; and
a data acquiring module, adapted to query whether the webpage data corresponding to a webpage access request is stored in the optimized cache area when the webpage access request is initiated, if stored, read the webpage data directly from the optimized cache area; if not stored, trigger a default cache module of a browser to query whether the webpage data is stored in a default cache area of the browser.

According to still another aspect of the present invention, a browser for accessing to webpage is provided, which comprises:

a protocol processor, comprising the device for accessing to webpage as described in any one of claims 11-15.

According to still another aspect of the present invention, a computer program is provided, which comprises computer readable codes, wherein, when the computer readable codes are operated in a terminal equipment, the terminal equipment executing the method for accessing to webpage as described in any one of claims 1-10.

According to still another aspect of the present invention, a computer readable medium is provided, in which the computer program of claim 18 is stored.

The advantageous effects of the present invention are as follows:

Firstly, the present invention implements a new configurable, operable and maintainable cache mechanism, which does not intend to substitute the original cache mechanism of the browser but is completely compatible with the original cache mechanism of the browser, and which may be considered as a supplement of the cache mechanism of the browser. Based on the present invention, when a browser accesses to a webpage, webpage data is read from the optimized cache area provided by the present invention firstly; when the webpage data cannot be read from the optimized cache area, in turn the cache mechanism of the browser is used to read the webpage data from the default cache area of the browser. Therefore, when the browser accesses to the webpage first time, although the default cache area of the browser does not have the webpage data, once the webpage data is pre-configured to the optimized cache area, they can be read directly from the optimized cache area, thus the accessing speed is improved.

Meanwhile, cache data in the optimized cache area may not be regularly cleaned as long as it is configured, even if the browser regularly executes a cleaning mechanism, the cache data in the optimized cache area may not be influenced. Thus, by the supplementary cache mechanism, cached files may not be cleaned by the browser or other software, thereby solving the problem of the cache files of websites being automatically cleaned by the browser frequently, and reducing the occupation of bandwidth of servers of some special websites. The present invention is especially applicable to webpage access having complex webpage script.

Secondly, taking over a network request of the Http (Hypertext transfer protocol) is implemented by a self-created APPS (Asynchronous Pluggable Protocols) processor using the APPS of the Windows in the present invention. By such take-over, required cache mechanism may be implemented conveniently and efficiently.

As a matter of course, any one of products implementing the solutions of the present invention is not necessarily required to implement all the advantages as described above at the same time.

The above description is merely an overview of the technical solutions of the present invention. In order to understand the technical means of the present invention more clearly, to implement in accordance with the content of the specification, and to make above and other objects, features and advantages of the present invention more apparent, there are provided detailed embodiments of the present invention hereafter.

### BRIEF DESCRIPTION OF THE DRAWINGS

Other advantages and benefits will become apparent to the skilled in the art by reading the following detailed description of the preferred embodiments. The accompanying drawings are provided only for the purpose of illustrating the preferred embodiments, and should not be constructed as limiting the present invention thereto. Moreover, the same components will indicated by the same reference symbols in the whole drawings. In the accompanying drawings:

FIG. 1 is a flow chart schematically showing a method for accessing to webpage according to an embodiment of the present invention;

FIG. 2 is a flow chart schematically showing a flow of a method for accessing to webpage according to an embodiment of the present invention;

FIG. 3 is a structure diagram schematically showing a device for accessing to webpage according to an embodiment of the present invention;

FIG. 3A is a schematic module structure diagram of a preloading module according to an embodiment of the present invention;

FIG. 4 is a structure diagram schematically showing a browser for accessing to webpage according to an embodiment of the present invention;

FIG. 5 is a block diagram of a terminal device for executing the methods for accessing to webpage according to the present invention; and

FIG. 6 schematically shows a memory unit which is used to store or carry program codes for implementing the methods for accessing to webpage according to the present invention.

### DETAILED DESCRIPTION OF THE EMBODIMENTS

The present invention will be further described in combination with the accompanying drawings and the specific embodiments hereinafter.

The embodiments of the present invention implement a new configurable, operable and maintainable cache mechanism, which does not intend to substitute the original cache mechanism of the browser but is completely compatible with the original cache mechanism of the browser, and which may be considered as a supplement of the cache mechanism of the browser.

Hereinafter, implementation of the present invention will be described in detail by way of the embodiments.

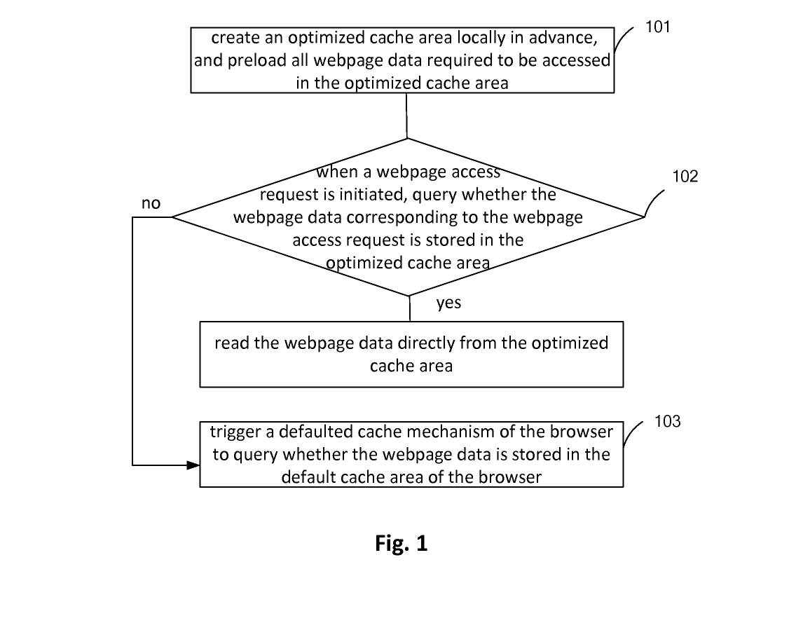

Referring to FIG. 1, it is a flow chart of a method for accessing to webpage according to an embodiment of the present invention.

At step 101, create an optimized cache area locally in advance, and preload all webpage data required to be accessed in the optimized cache area.

In this embodiment, relevant files and index files (collectively referred to as webpage data or cache files) of websites which is required to increase the access speed can be installed in a user's machine in advance through an installation package or a updating module of a client, and the webpage data may be cached by creating the optimized cache area in the user's machine. Specifically, the webpage data or the cache files may include contents of the webpage per se, such as images, text, etc., also may include Cookie files, and may further include webpage script, etc.

Herein, the optimized cache area is different from the default cache area of the browser. The webpage cache mechanism supported by the browser may store the webpage data, to which the browser has ever accessed, in the default cache area, and automatically clean and maintain the default cache area. Whereas, the optimized cache area described in the embodiments of the present invention does not cache the webpage data to which the browser has ever accessed, but caches the webpage data of all the website which is possible to be accessed by means of preloading, wherein these webpage data may be never accessed by the browser.

Further, this embodiment provides two preloading manners as follows:

One manner is, after the installation of the installation package or the updating module of the client is completed, all the webpage data required to be accessed may be automatically downloaded from a server and stored in the optimized cache area.

Another manner is that the installation package or the updating module of the client are built in all the webpage data required to be accessed, i.e., all the webpage data required to be accessed is pre-configured in the installation package or the updating module of the client, and all the webpage data is stored in the optimized cache area after the installation is completed.

Any one of the preloading manners is feasible in practical applications. Moreover, no matter which kind of preloading manner is adopted, the preloaded contents may be configured, i.e., the webpage data (such as script, Cookie, images and text, etc.) of which websites necessary to be preloaded may be configured according to the user's requirements.

At step 102: when a webpage access request is initiated, query whether the webpage data corresponding to the webpage access request is stored in the optimized cache area, if stored, read the webpage data directly from the optimized cache area.

In specific query, it is queried according to an index of the cache files. The index is an index file which contains a corresponding relation between URL (Universal Resource Locator) of the webpage and the cache files in the optimized cache area. When a browser accesses to webpage and sends an Http request of webpage resource, it may search the index file. If corresponding cache files are found, then read the corresponding cache files directly, otherwise step 103 will be executed to return to a system to perform a default processing.

As it can be seen from above, when the browser accesses to the webpage and sends the request, the browser may query the optimized cache area firstly, rather than the original default cache area of the browser.

At step 103, if the webpage data corresponding to the webpage access request is not stored, trigger a defaulted cache mechanism of the browser to query whether the webpage data is stored in the default cache area of the browser.

When the webpage data has been stored in the default cache area of the browser, the webpage data may be read directly from the default cache area of the browser.

When the webpage data has not been stored in the default cache area of the browser, the webpage data may be downloaded from a server.

The above is the default processing of the system, i.e., the cache mechanism supported by the browser is used.

To sum up, no matter whether to read the webpage data from the optimized cache area, read the webpage data from the default cache area of the browser, or download the webpage data from the server, after the cache files required to be accessed are obtained, successively perform subsequent processing, such as display the webpage data on the client.

As it can be seen from the above flow, when the browser accesses to the webpage first time, although the default cache area of the browser does not have the webpage data, once the webpage data is pre-configured to the optimized cache area, they can be read directly from the optimized cache area, thus the accessing speed is improved.

Meanwhile, the cache data in the optimized cache area may not be regularly cleaned as long as it is configured, even if the browser regularly executes a cleaning mechanism, the cache data in the optimized cache area may not be influenced. Thus, by the supplementary cache mechanism, cached files may not be cleaned by the browser or other software, thereby solving the problem of the cache files of websites being automatically cleaned by the browser frequently, and reducing the occupation of bandwidth of servers of some special websites. In order for the person skilled in the art to further understand the implementation of the present invention, more specific embodiments will be given to describe the present invention in detail hereinafter.

In this embodiment, taking over a network request of the Http protocol is implemented by a self-created APPS (Asynchronous Pluggable Protocols) processor using the APPS of the Windows, so as to obtain all processing authorities in the Http protocol of the browser. By such take-over, required cache mechanism may be implemented conveniently and efficiently.

APPS processor is a solution that processes customized URL protocol(s) or a solution that filters data for appointed MIME type on the Windows platform, which allows to substitute the default URL protocol(s) (such as http protocols or about protocols, etc.) of the Windows system through APPS.

APPS processor is an apartment-threaded COM (Component Object Model) object that handles any calls made to the protocol scheme for which it is registered. When a client program makes a request, Urlmon (URL processing module of the Windows) looks up the protocol scheme in the registry and creates an instance of the protocol process program registered for this protocol solution. If the protocol registration solution can be successfully mapped to a class identifier (CLSID) of the protocol processor, the CoCreateInstance method of the IClassFactory interface may be called. The APPS processor may obtain the instance through the IClassFactory::CreateInstance function.

In the Windows system, the original cache mechanism of the browser can be implemented through the APPS processor (default APPS for short) of the system. In this embodiment, an APPS processor is self-created (self-created APPS for short) and used as a supplementary to the default APPS of the system. The cooperation of the two APPSs can provide an increase in the speed of webpage access while preventing the cache from being cleaned automatically by the browser.

Herein, the self-created APPS can be used as a separate plug-in installed to the IE browser, or be used as a part of the browser functions; the present invention may be implemented as a client installed with a brand new browser having the APPS. No matter whether to install a separately plug-in or a brand new browser, the self-created APPS may create an optimized cache area in the client after the installation is completed, and store all the pre-configured webpage data required to be accessed in the optimized cache area.

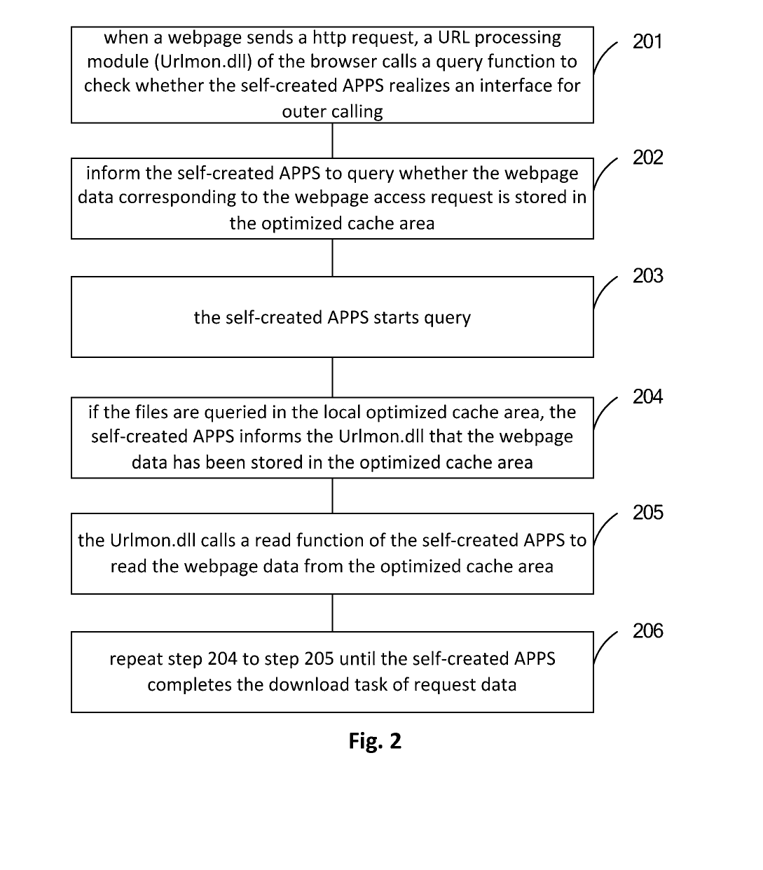

The following flow chart FIG. 2 shows how to realize an http network request through APPS and read data from a customized optimized cache area rather than obtain from the network.

Referring to FIG. 2, it is a schematic flowchart of accessing to webpage according to another embodiment of the present invention.

At step 201, when a webpage sends a http request, a URL processing module (Urlmon.dll) of the browser calls a query function to check whether the self-created APPS realizes an interface for outer calling.

Specifically, the Urlmon.dll of the system calls QueryInterface function (which is a standard function of Com, with a function of querying interface) firstly to check whether the self-created APPS realizes an IInternetProtocol interface, wherein, the IInternetProtocol interface is an interface exposed by the self-created APPS to the outer call, which is responsible to communicate with an IInternetProtocolSink interface in the downloading operation (refers to a process of network download).

If the interface for outer calling is realized, enter step 202 to inform the self-created APPS to query whether the webpage data corresponding to the webpage access request is stored in the optimized cache area.

If the interface for outer calling is not realized, inform the default APPS of the browser (also called as a default cache module of the browser) to query whether the webpage data corresponding to the webpage access request is stored in the default cache area of the browser. The subsequent procedures are omitted herein.

At step 202, inform the self-created APPS to query whether the webpage data corresponding to the webpage access request is stored in the optimized cache area.

If stored, execute step 203; otherwise, inform the default APPS of the browser. The subsequent procedures are omitted herein.

Specifically, the Urlmon.dll of the system calls an IInternetProtocolRoot::Start method of the self-created APPS and transmits the address of the IInternetProtocolSink interface of the Urlmon.dll.

Herein, the IInternetProtocolRoot::Start method may be used to query whether the data corresponding to a URL required to be accessed is stored in the optimized cache area.

Herein, the IInternetProtocolSink interface is an interface that may be used to receive related information and notification from APPS data.

At step 203, the self-created APPS starts query.

Firstly, query data from a local optimized cache area. If files corresponding to a special webpage that requires to be accelerated are stored in this local optimized cache area, the files may be read from the local optimized cache area, rather than request on the files from the network, so as to implement acceleration for a complex webpage. Otherwise, if the files can not be queried from the local optimized cache area, the default APPS of the system may be called.

At step 204, if the files are queried in the local optimized cache area, the self-created APPS informs the Urlmon.dll that the webpage data has been stored in the optimized cache area.

Specifically, after the corresponding data is read by the self-created APPS from the local optimized cache area, by the self-created APPS calls an IInternetProtocolSink:ReportData method of the Urlmon.dll to inform the Urlmon.dll.

At step 205, the Urlmon.dll calls a read function of the self-created APPS to read the webpage data from the optimized cache area.

Specifically, the Urlmon.dll of the system calls an IInternetProtocol::Read method of the self-created APPS to read.

At step 206, repeat step 204 to step 205 until the self-created APPS completes the download task of request data.

The above flows can increase loading speed of webpage, and even can pre-download all webpage files of websites that user needs to access through a client software, thereby reducing network connection speed and times. Moreover, it can prevent the cache from being automatically cleaned up by the browser.

In addition, it should be explained that the above embodiments of the present invention are especially applicable to access to and load webpage having complex webpage script. When accessing to theses complex webpage, it will take lots of time if downloading complex webpage script is downloaded from a server; while if the method according to the embodiments of the present invention is employed, that is, preload these webpage data to the local optimized cache area firstly by the preloading manners, and then read the webpage data from the local optimized cache area, then the access speed will be increased significantly and the acceleration effect of complex script webpage may be more remarkable.

It should be explained that the aforementioned method embodiments are described as a series of action combination for a brief description, whereas it should be understood by a person skilled in the art that the present invention is not limited to the described action orders, and some steps may be performed in other orders or performed simultaneously according to the present invention. Moreover, it also should be understood by a person skilled in the art that each of the embodiments described in the specification is preferable embodiment, and thus the related actions are not necessary in the present invention.

On the basis of the above description of the method embodiments, corresponding device embodiments are further provided by the present invention as follows.

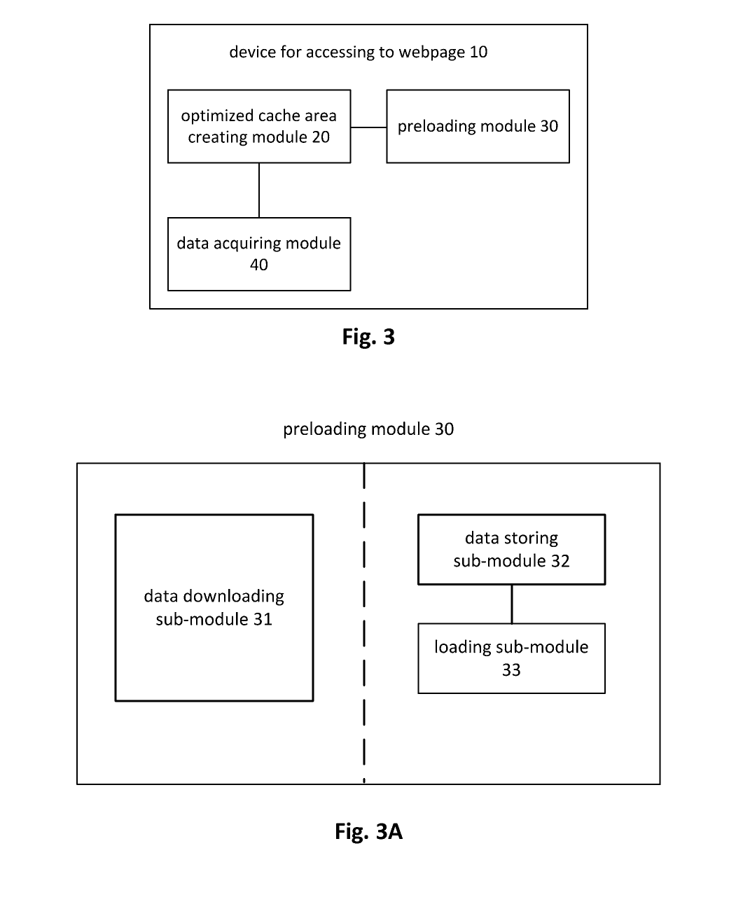

Referring to FIG. 3, it is a structure diagram of a device for accessing to webpage according to the embodiments of the present invention.

The device 10 for accessing to webpage may comprise an optimized cache area creating module 20, a preloading module 30 and a data acquiring module 40.

In the above, the optimized cache area creating module 20 is adapted to create an optimized cache area locally in advance.

The preloading module 30 is adapted to pre-load all webpage data required to be accessed in the optimized cache area.

The data acquiring module 40 is adapted to query whether the webpage data corresponding to a webpage access request is stored in the optimized cache area when the webpage access request is initiated, if stored, read the webpage data may from the optimized cache area directly; if not stored, trigger a default cache module of a browser to query whether the webpage data is stored in a default cache area of the browser.

The default cache module of the browser is further adapted to read the webpage data directly from the default cache area of the browser when the webpage data is stored in the default cache area of the browse; and download the webpage data from a server when the webpage data is not stored in the default cache area of the browser.

Herein, the default cache module of the browser is adapted to realize a build-in webpage cache mechanism of the browser, which may be a build-in APPS of the browser.

Preferably, referring to FIG. 3A, it is a schematic module structure diagram of a preloading module 30 according to an embodiment of the present invention. As schematically shown in FIG. 3A, since two preloading manners are provided in the above method embodiments, the preloading module 30 may respectively comprise the following sub-modules corresponding to the two preloading manners.

The preloading module 30 may comprise:

a data downloading sub-module 31 that is adapted to download all webpage data required to be accessed from a server automatically, and store the all webpage data in the optimized cache area.

The preloading module 30 may also comprise:

a data storing sub-module 32 that is adapted to store all webpage data required to be accessed; and
a loading sub-module 33 that is adapted to store all the webpage data required to be accessed in the data storing sub-module in the optimized cache area.

As a matter of course, the preloading module 30 may also comprise both of above sub-modules that realize the two configuration manners at the same time.

Since the above device embodiments are substantially similar to the method embodiments, the description thereof is relatively brief. As for the related parts, reference may be made to the corresponding description of the method embodiments.

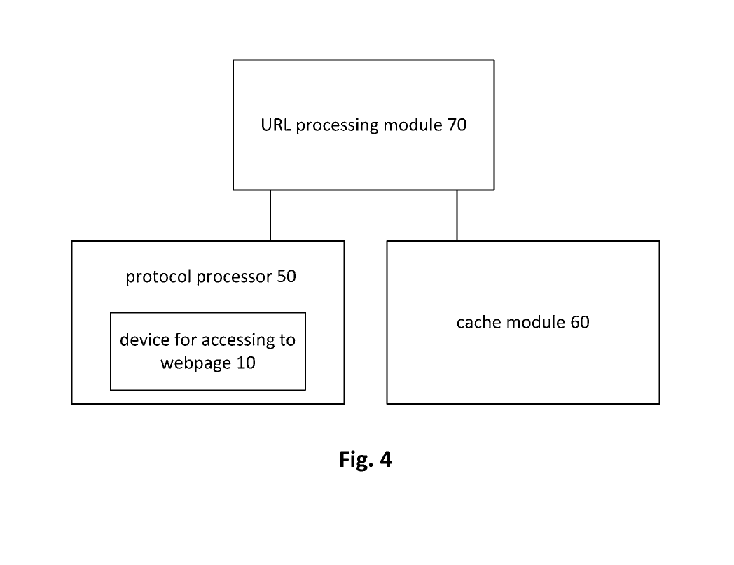

The device for accessing to webpage may be used as a separate plug-in installed to the IE browser, or as a part of the browser function, as shown in FIG. 4.

Referring to FIG. 4, it is a structure diagram of a browser for accessing to webpage according to the embodiments of the present invention.

The browser may comprise a protocol processor 50 that may include the device 10 for accessing to webpage as shown in FIG. 3. The description thereof can be referred to FIG. 3 and omitted herein.

In addition, the browser may further comprise a cache module 60 that is adapted to realize the default webpage cache mechanism of the browser.

Preferably, the browser may further comprise a URL processing module 70 that is adapted to call a query function to check whether the protocol processor 50 realizes an interface for outer calling when the webpage access request is initiated; if so, inform the protocol processor 50 to query whether the webpage data corresponding to the webpage access request is stored in the optimized cache area; and if not, inform the default cache module 60 of the browser to query whether the webpage data corresponding to the webpage access request is stored in the default cache area of the browser.

To sum up, the device or the browser for accessing to webpage implement a new configurable, operable and maintainable cache mechanism, which does not intend to substitute the original cache mechanism of the browser but is completely compatible with the original cache mechanism of the browser, and which may be considered as a supplement of the cache mechanism of the browser. By the supplementary cache mechanism, cached files may not be cleaned by the browser or other software, thereby solving the problem of the cache files of websites being automatically cleaned by the browser frequently, and reducing the occupation of bandwidth of servers of some special websites.

Each of members according to the embodiments of the present invention can be implemented by hardware, or implemented by software modules operating on one or more processors, or implemented by the combination thereof. A person skilled in the art should understand that, in practice, a microprocessor or a digital signal processor (DSP) may be used to realize some or all of the functions of some or all of the members of the browser device according to the embodiments of the present invention. The present invention may further be implemented as equipments or device programs (for example, computer programs and computer program products) for executing some or all of the methods as described herein. The programs for implementing the present invention may be stored in a computer readable medium, or have a form of one or more signal. Such a signal may be downloaded from the Internet websites, or be provided in carrier signal, or be provided in other manners.

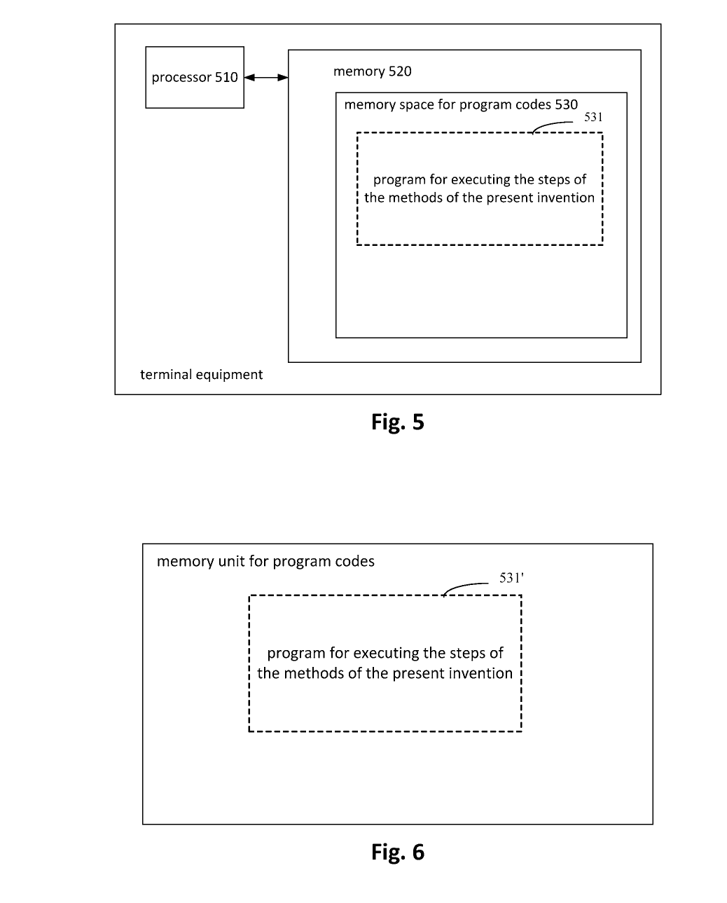

For example, FIG. 5 schematically shows a block diagram of a terminal equipment for executing the methods for accessing to webpage according to the present invention. Traditionally, the terminal equipment comprises a processor 510 and a computer program product or a computer readable medium in form of a memory 520. The memory 520 may be electronic memories such as flash memory, EEPROM (Electrically Erasable Programmable Read-Only Memory), EPROM, hard disk or ROM. The memory 520 has a memory space 530 for executing program codes 531 of any steps of the above methods. For example, the memory space 530 for program codes may comprise respective program codes 531 used to implement the various steps in the above mentioned methods. These program codes may be read from and/or be written into one or more computer program products. These computer program products comprise program code carriers such as hard disk, compact disk (CD), memory card or floppy disk. These computer program products are usually the portable or stable memory units as shown in reference FIG. 6. The memory unit may be provided with memory sections, memory spaces, etc., similar to the memory 520 of the terminal equipment as shown in FIG. 5. The program codes may be compressed in an appropriate form. Usually, the memory unit includes computer readable codes 531′, which can be read by processors such as 510. When these codes are operated by the server, the server may execute each step as described in the above methods.

The terms “one embodiment”, “an embodiment” or “one or more embodiment” used herein means that, the particular feature, structure, or characteristic described in combination with the embodiments may be included in at least one embodiment of the present invention. In addition, it should be noticed that, the word “in one embodiment” used herein is not necessarily always referring to the same embodiment.

A number of specific details have been described in the specification provided herein. However, it is possible to be understood that the embodiments of the present invention may be practiced without these specific details. In some examples, in order not to confuse the understanding of the specification, the known methods, structures and techniques are not shown in detail.

It should be noticed that the above-described embodiments are intended to illustrate but not to limit the present invention, and alternative embodiments can be devised by the person skilled in the art without departing from the scope of claims as appended. In the claims, any reference symbols between brackets should not form a limit of the claims. The word “comprising/comprise” does not exclude the presence of elements or steps not listed in a claim. The word “a” or “an” in front of element does not exclude the presence of a plurality of such elements. The present invention may be achieved by means of hardware comprising a number of different components and by means of a suitably programmed computer. In the unit claim listing a plurality of devices, some of these devices may be implemented by the same hardware. The words “first”, “second”, and “third”, etc. do not denote any order. These words can be interpreted as a name.

Additionally, it should also be noticed that the language used in the present specification is chosen for the purpose of readability and teaching, rather than selected in order to explain or define the subject matter of the present invention. Therefore, it is obvious for an ordinary person skilled person in the art that many modifications and variations could be made without departing from the scope and spirit of the claims as appended. For the scope of the present invention, the disclosure of present invention is illustrative but not restrictive, and the scope of the present invention is defined by the appended claims.

1. A method for accessing to webpage, comprising:
creating an optimized cache area locally in advance, and preloading all webpage data required to be accessed in the optimized cache area; and
when a webpage access request is initiated, querying whether the webpage data corresponding to the webpage access request is stored in the optimized cache area, if stored, reading the webpage data directly from the optimized cache area; if not stored, triggering a defaulted cache mechanism of a browser to query whether the webpage data is stored in a default cache area of the browser.

2. The method according to claim 1, wherein the defaulted cache mechanism of the browser further comprises:
when the webpage data is stored in the default cache area of the browser, reading the webpage data directly from the default cache area of the browser; and
when the webpage data is not stored in the default cache area of the browser, downloading the webpage data from a server.

3. The method according to claim 1, wherein the step of creating an optimized cache area locally in advance comprises:
installing a protocol processor in local, and creating the optimized cache area by the protocol processor.

4. The method according to claim 3, wherein the step of preloading all webpage data required to be accessed in the optimized cache area comprises:
after the installation is complete, the protocol processor automatically downloading all webpage data required to be accessed from a server and storing them in the optimized cache area.

5. The method according to claim 3, wherein the step of preloading all webpage data required to be accessed in the optimized cache area comprises:
pre-setting all webpage data required to be accessed in an installation package of the protocol processor, and storing all webpage data required to be accessed which is in the installation package in the optimized cache area after the installation is complete.

6. The method according to claim 3, wherein, when the webpage access request being initiated, the method further comprises:
a URL processing module of the browser checking whether the protocol processor realizes an interface for outer calling;
if yes, informing the protocol processor to query whether the webpage data corresponding to the webpage access request is stored in the optimized cache area; and
if not, informing a default cache module of the browser to query whether the webpage data corresponding to the webpage access request is stored in the default cache area of the browser.

7. The method according to claim 6, wherein, before the step of reading the webpage data directly from the optimized cache area, the method further comprises:
the protocol processor informing the URL processing module of the browser that the webpage data is stored in the optimized cache area.

8. The method according to claim 6, wherein, the step of reading the webpage data directly from the optimized cache area comprises:
the URL processing module of the browser calling a read function of the protocol processor to read the webpage data from the optimized cache area.

9. The method according to claim 1, wherein the webpage data comprises webpage script data.

10. The method according to claim 3, wherein the protocol processor comprises an asynchronous pluggable protocol processor, and the method further comprises:
taking over a network request of an Http protocol by the asynchronous pluggable protocols processor which is created, so as to obtain a processing authority in all Http protocols of the browser to implement the optimized cache area which is required.

11. A device for accessing to webpage, comprising:
an optimized cache area creating module, adapted to create an optimized cache area locally in advance;
a preloading module, adapted to preload all webpage data required to be accessed in the optimized cache area; and
a data acquiring module, adapted to query whether the webpage data corresponding to a webpage access request is stored in the optimized cache area when the webpage access request is initiated, if stored, read the webpage data directly from the optimized cache area; if not stored, trigger a default cache module of a browser to query whether the webpage data is stored in a default cache area of the browser.

12. The device according to claim 11, wherein the default cache module of the browser is further adapted to read the webpage data directly from the default cache area of the browser when the webpage data is stored in the default cache area of the browse; and download the webpage data from a server when the webpage data is not stored in the default cache area of the browser.

13. The device according to claim 11, wherein the preloading module comprises:
a data downloading sub-module, adapted to download all webpage data required to be accessed from a server automatically, and store the all webpage data in the optimized cache area.

14. The device according to claim 11, wherein the preloading module comprises:
a data storing sub-module, adapted to store all webpage data required to be accessed; and
a loading sub-module, adapted to store the all webpage data required to be accessed in the data storing sub-module in the optimized cache area.

15. The device according to claim 11, wherein the webpage data comprises webpage script data.

16. (canceled)

17. (canceled)

18. (canceled)

19. A computer readable medium, in which a computer program is stored, wherein the computer program comprises computer readable codes, wherein, when the computer readable codes are operated in a terminal equipment, the terminal equipment executing the method for accessing to webpage as described in claim 1.
